(19) United States
(12) Patent Application Publication
(10) Pub. No.: US 2026/0016115 A1
(43) Pub. Date: Jan. 15, 2026

(54) ADJUSTABLE CHOCK HAVING SLIDING FEATURE AND MOUNTING ASSEMBLY INCLUDING THE ADJUSTABLE CHOCK

(71) Applicant: AKTIEBOLAGET SKF, Goteborg (SE)

(72) Inventor: Rene VERMEULEN, Spijkenisse (NL)

(21) Appl. No.: 19/262,291

(22) Filed: Jul. 8, 2025

(30) Foreign Application Priority Data
Jul. 15, 2024 (DE) 102024206626.5

(51) Int. Cl. F16M 11/12; F16B 43/00; F16M 11/04

(52) U.S. Cl. CPC F16M 11/12; F16B 43/002; F16M 11/043

(57) ABSTRACT

A mounting assembly includes an adjustable chock and a rod having an external thread. The adjustable chock includes a first component having an upper bearing surface and a first through-hole having an internal thread, a second component having a lower bearing surface and having a second through hole, and a bearing element having an upper surface and a third through-hole and a lower bearing surface in contact with the upper bearing surface of the first component. A portion of the first component extends into the second through hole, the rod extends through the first through hole and the third through hole, and the external thread of the rod engages the internal thread of the first though hole.

### CROSS-REFERENCE

This application claims priority to German patent application no. 10 2024 206 626.5 filed on Jul. 15, 2024, the contents of which are fully incorporated herein by reference.

### TECHNOLOGICAL FIELD

The present disclosure relates to an adjustable chock configured to allow limited transverse movement of an object supported by the adjustable chock and to a mounting assembly that includes the adjustable chock.

### BACKGROUND

Some equipment is subject to important temperature and/or pressure variations that must be accounted for in the design. For example, in case of a fuel tank, it is of paramount importance to allow deformations due to variations in the pressure and/or in the temperature of the fluid in the tank. Otherwise, if such deformations are obstructed, large stresses can develop, thus reducing the structural safety margins of the equipment and the support.

Usually, at the bearing or support level, allowing such deformations is done by fixing one side of the fuel tank and letting the fuel tank slide at the opposed side. In general, a grout or an epoxy resin is used to chock the supports of such a fuel tank. Nevertheless, while the grout or the epoxy resin is curing, operational activities are limited if not forbidden in the vicinity of the grout or of the epoxy resin.

Adjustable levelling pads or chocks are easy-to-set devices that are generally configured to provide both support and vertical alignment capability with or without an associated anchor bolt. As adjustable chocks do not need curing they expedite installation compared to grout or epoxy resin alternatives.

Adjustable chocks are well known in the art. Reference can be made to FIGS. 1A and 1B which illustrate a known adjustable chock 10. The adjustable chock 10 is mounted to connect the frame 1 of a machine or equipment to a foundation or support 2, for example made of concrete or steel. Anchoring the frame 1 to the support 2 is done here with an anchor bolt 3.

The adjustable chock 10 comprises a first component 11 or shaft element, a second component 12 or annular element and a third component 13 or bearing element. The first, second and third components 11, 12, 13 are coaxial along a vertical axis Z-Z′.

The first component 11 has an upper portion 11a and a lower portion 11b that has an external thread 11c. As illustrated in FIG. 1B, the upper portion 11a has an upper surface 11d, part of which is concave. The first component 11 has a through-hole 14 for accommodating a shank 3a of the bolt 3.

The second component 12 has a second through-hole 12a having an internal thread 12b configured to engage with the external thread 11c of the first component 11. The threaded portions 11c, 12b cooperate with each other to allow for vertical adjustment.

The third component 13 sits between the frame 1 and the upper portion 11a of the first component 11. As shown in FIG. 1B, the third component 13 has a lower surface 13a engaging with the upper surface 11d of the first component 11. The lower surface 13a and the upper surface 11d are complementarily shaped so as to facilitate slight adjustment of the positions between the first component 11 and the third component 13 relative to one another, for example, in order to accommodate slight deviations from the frame 1 of the machine and the support 2.

The third component 13 has a through hole 16 having a diameter larger than the diameter of the first through-hole 14 in order to allow the shank 3a of the bolt 3 to pass through the through hole 16 if an axis of symmetry of the lower surface 11d of the first component 11 is not aligned with an axis of symmetry of the lower surface 13a of the third component 13. This allows for the accommodation of deviations from horizontal, parallel orientations of the frame 1 of the machine and the support 2.

The chock 10 is sandwiched between the frame 1 of the machine and the support 2 and securely held in place by the bolt 3 and a nut 4 screwed on a part of the shank 3a extending beyond the frame 1 of the machine. The height of the adjustable chock 10 is adjusted by screwing the first component 11 further into or further out of the second component 12.

When installed, the chock 10 is subjected to the weight load of the frame 1 of the machine, and, more generally, to reaction forces transmitted by the support 2 and/or by the frame 1. The axial stiffness of an adjustable chock 10 depends on the axial load capacity and its transverse stiffness depends on the transverse load capacity. However, known adjustable chocks do not allow sliding of the supported equipment and so they cannot be used for accommodating movements caused by deformations of the supported equipment. It would therefore be desirable to provide an adjustable chock that allows sliding of the supported equipment.

### SUMMARY

The disclosure relates to a kit comprising an adjustable chock including a first component having a first through-hole, a second component having a second through-hole, and a bearing element having a third through-hole. The second component is secured onto an outer surface of the first component and has a lower bearing surface. The bearing element has a lower bearing surface in contact with an upper bearing surface of the first component and has an upper bearing surface.

The adjustable chock further includes a rod having an external thread which rod extends through the through-holes. The through-hole of the first component has an internal thread cooperating with the external thread of the rod.

Such a kit forms an easy-to-set levelling device that expedites installation time as no curing is needed. Preferably, the kit comprises a bottom nut mounted on a first end of the rod, the bottom nut being fixed by a first tightening torque. Such a kit can easily be secured to a support with the help of the rod and the bottom nut.

Preferably, the kit comprises a top nut mounted on a second opposite end of the rod, the top nut being fixed by a second tightening torque. Advantageously, the second tightening torque of the top nut is lower than the first tightening torque of the bottom nut. This feature allows securing the kit to a support.

In one embodiment, the kit comprises a sliding element provided on the upper bearing surface of the bearing element that has a lower friction coefficient than the upper bearing surface of the bearing element. The sliding element facilitates sliding by reducing friction.

For example, the sliding element may be a coating provided on the upper bearing surface of the bearing element or a washer mounted on the upper bearing surface of the bearing element. The kit may include a stainless-steel plate provided on the sliding element. The stainless-steel plate reduces friction and protects the sliding element. The surface of the stainless-steel plate that is in contact with the first anti-friction washer may have an average roughness Ra less than 0.8 μm.

The disclosure also relates to an assembly comprising the kit as previously defined. The assembly further comprises a frame provided with a fourth through-hole and a support provided with a fifth through-hole. The rod of the kit is mounted in the through-holes, the fourth through-hole having a width larger than the diameter of the rod such that a space is provided between the fourth through-hole of the frame and the rod. This configuration allows sliding of the frame.

Preferably, the kit of the assembly further comprises an anti-friction washer provided between the top nut and the frame. The anti-friction washer facilitates the sliding of the frame by reducing friction.

### BRIEF DESCRIPTION OF THE DRAWINGS

The present disclosure and its advantages will be better understood by studying the detailed description of specific embodiments given by way of a non-limiting examples and illustrated by the appended drawing in which:

FIG. 1A is a perspective view of a conventional adjustable chock.

FIG. 1B is a side elevational view of the adjustable chock of FIG. 1A, partly in section and placed between a support and an object supported by the adjustable chock.

FIG. 2 is a cross-section view of a kit according to an embodiment of the present disclosure mounted between a support and an object supported by the adjustable chock.

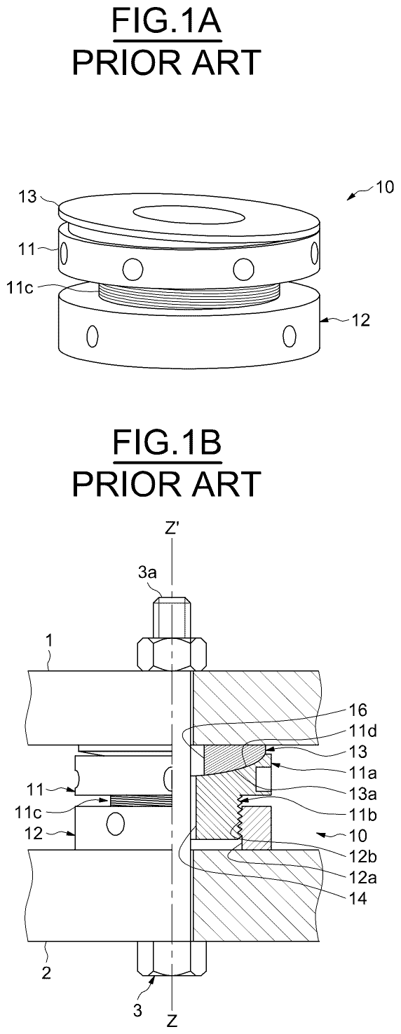

### DETAILED DESCRIPTION

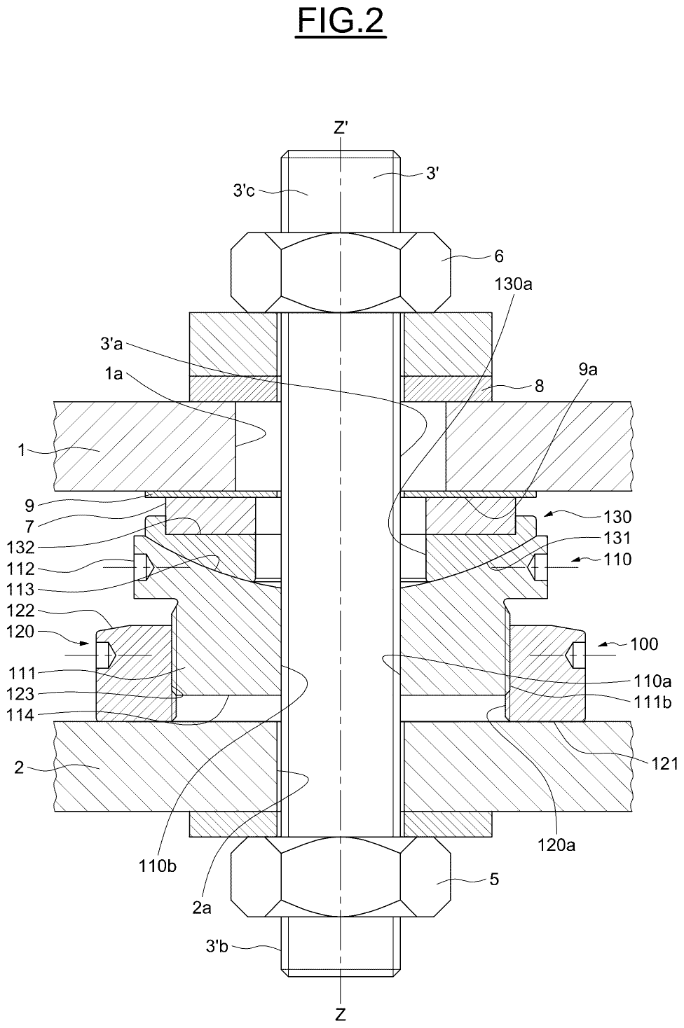

As shown in FIG. 2, the kit comprises an adjustable chock 100 mounted to connect a frame 1 of an equipment or a machine to a foundation or support 2. Anchoring the frame 1 to the support 2 is done here with a rod 3′ provided with an external thread 3′a.

The adjustable chock 100 comprises a first component 110 or shaft element, a second component 120 or lower adjustable part and a third component or bearing element 130. The first, second and third components 110, 120, 130 are coaxial along a vertical axis Z-Z′. The chock 100 is symmetric relative to the longitudinal axis Z-Z′. The first, second and third components 110, 120, 130 are made, for example, of steel, preferably high-grade steel.

The first component 110 of the adjustable chock comprises a lower portion 111 and an upper flange 112. The first component 110 has an external thread 111b. The external thread 111b is formed on the outer surface of the lower portion 111. The upper flange 112 protrudes radially outwards with respect to the lower portion 111. The upper flange 112 has an upper bearing surface 113 that has a convex portion. The upper surface 113 is rotationally symmetric. The upper surface 113 forms the upper surface of the first component 110.

The first component 110 has a first through-hole 110a extending axially from the upper surface 113 to a lower surface 114 of the first component 110. The first through-hole 110a has an internal thread 110b cooperating with the external thread 3′a of the rod 3′.

For example, the rod 3′ comprises a shank and at least one external thread portion forming the external thread 3′a. The external thread 3′a may comprise several threaded portions spaced axially from each other. Alternatively, the rod 3′ may be a full threaded rod. In one other example, the rod 3′ may be a bolt.

The second component 120 of the adjustable chock has a lower bearing surface 121 and an upper surface 122. The lower and upper surfaces 121, 122 axially delimit the second component 120. The lower surface 121 is axially opposite to the upper surface 122. The upper surface 122 is located axially below the upper flange 112 of the first component. The second component 120 has a second through-hole 120a extending axially from the upper surface 122 to the lower surface 121. The second through-hole 120a has an internal thread 123 configured to engage with the external thread 111b of the first component 110. The threads 111b, 123 cooperate together and allow for vertical adjustment of the first component 110 and the second component 120.

The first component 110 is movable with respect to the second component 120 between a partially screwed position, shown in FIG. 2, in which the threads 111b of the first component 110 partially cooperate with the threads 123 of the second component 120 and a totally screwed position, not shown, in which the lower surface of the upper flange 112 of the first component axially abuts against the upper surface 122 of the second component.

The bearing element 130 of the adjustable chock sits on the upper flange 112 the first component 110. The bearing element 130 has a lower bearing surface 131 and an upper bearing surface 132. The lower surface 131 is axially opposite to the upper surface 132. The lower surface 131 is in contact with the upper surface 113 of the first component. The lower surface 131 has a convex shape and is rotationally symmetric.

The lower surface 131 and the upper surface 113 are complementarily shaped so as to facilitate slight adjustment of the positions between the first component 110 and the bearing element 130 relative to one another, for example, in order to accommodate slight deviations from the frame 1 and the support 2. The radius of curvature of the lower surface 131 of the bearing element 130 corresponds to the radius of curvature of the upper surface 113 of the first component 110. In the illustrated example, the upper bearing surface 132 of the bearing element 130 extends radially. The bearing element 130 has a third through-hole 130a extending axially from the upper surface 132 to the lower surface 131.

In the described example, the bearing element 130 is made, for example, of steel. Alternatively, the bearing element 130 may be made of a low friction material, for example a metal with a solid lubricant such as PTFE.

In the exemplary embodiment shown in FIG. 2, the kit comprises a bottom nut 5 mounted on a first end 3′b of the rod 3′ and a top nut 6 mounted on a second opposite end 3′c of the rod 3′. The bottom nut 5 is fixed by a first tightening torque and the top nut 6 is fixed by a second tightening torque. Preferably, the second tightening torque of the top nut 6 is lower than the first tightening torque of the bottom nut 5. Even more preferably, the first tightening torque of the bottom nut 5 is much larger than the second tightening torque of the top nut 6. This means that the difference torque between the first and the second tightening torques allows pulling the first component 110 towards the support 2 by the rod 3′, and so, securing the kit onto the support 2. It should be noted that this is made possible by the mutual engagement of the threads 110b and 3′a.

As shown in FIG. 2, the frame 1 has a fourth through-hole 1a, and the support 2 has a fifth through-hole 2a. The rod 3′ extends through the first, the second, the third, the fourth and the fifth through-holes 110a, 120a, 130a, 1a, 2a.

Advantageously, the fourth through-hole 1a has a width larger than the diameter of the rod 3′ such that a space is provided between the fourth through-hole 1a of the frame 1 and the rod 3′. The space provided between the fourth through-hole 1a and the rod 3′ allows free sliding of the frame 1.

It should be noted that the space may be provided in only one direction. In this case, the kit forms a unidirectional sliding bearing, i.e. a bearing allowing sliding only in that direction or only along one line. Alternatively, the space may be provided in two or more directions, the kit forming a multidirectional sliding bearing. For example, a multidirectional sliding can be obtained by providing a fourth through-hole 1a with a circular shape having a diameter larger than the diameter of the rod 3′. It is of course possible to use different shapes for the fourth through-hole 1a.

In order to ease the sliding of the frame 1, the kit may comprise a sliding element 7 provided on the upper bearing surface 132 of the bearing element 130 and having a reduced friction coefficient, i.e. a lower friction coefficient than the upper bearing surface 132 of the bearing element 130.

For example, the sliding element 7 may comprise a plate or a washer mounted on the upper bearing surface 132, and/or may include a coating provided on the upper bearing surface 132. In the example shown in FIG. 2, the sliding element 7 is a washer made preferably of PTFE.

In order to ease even further the sliding of the frame 1, the kit may comprise an anti-friction washer 8 provided between the top nut 6 and the frame 1. Similarly to the sliding element 7, the anti-friction washer 8 is made of a material having a reduced friction coefficient. Such a material with a reduced friction coefficient comprises at least partly a metal (for example Ag, Sn, Cu) and/or a solid lubricant such as PTFE. For example, the anti-friction washer 8 may be made of PTFE.

As shown in FIG. 2, the kit may comprise a stainless-steel plate 9 sitting on the sliding element 7, especially if the roughness of the surface of the frame 1 is relatively high. However, the stainless-steel plate 9 may not be necessary in case the surface of the frame 1 is relatively smooth. For example, the surface 9a of the stainless-steel plate 9 that is in contact with the sliding element 7 has a roughness average Ra less than 0.8 μm.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved adjustable chocks.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A mounting assembly comprising:
an adjustable chock, and
a rod having an external thread,
wherein the adjustable chock comprises:
a first component having an upper bearing surface and a first through-hole having an internal thread,
a second component having a lower bearing surface and having a second through hole, and
a bearing element having an upper surface and a third through-hole and a lower bearing surface in contact with the upper bearing surface of the first component,
wherein a portion of the first component extends into the second through hole,
wherein the rod extends through the first through hole and the third through hole, and
wherein the external thread of the rod engages the internal thread of the first though hole.

2. The mounting assembly according to claim 1,
wherein the upper surface includes sliding means having a lower coefficient of friction than a material of the bearing element.

3. The mounting assembly according to claim 2,
wherein the sliding means comprises a coating on the upper surface of the bearing element.

4. The mounting assembly according to claim 2,
wherein the sliding means comprises a washer mounted on the upper surface of the bearing element.

5. The mounting assembly according to claim 4,
wherein the upper surface of the bearing element includes a depression and the washer is mounted in the depression.

6. The mounting assembly according to claim 5,
wherein the washer comprises a solid lubricant.

7. The mounting assembly according to claim 6,
including a steel plate mounted on the washer such that the washer is located between the steel plate and the bearing element.

8. A system comprising:
a support,
a frame, and
a mounting assembly according to claim 2 mounted between the support and the frame with the lower bearing surface of the second component in contact with the support and the sliding means in contact with frame,
wherein the frame includes a fourth through opening having a width greater than a diameter of the rod,
wherein the support includes a fifth through opening,
wherein the rod extends through the fourth through opening and the fifth through opening,
wherein a bottom nut is threaded onto a first end of the rod on a side of the support opposite the adjustable chock, and
wherein a top nut is threaded onto a second end of the rod on a side of the frame opposite the adjustable chock.

9. The system according to claim 8,
wherein the bottom nut is tightened against the support by a first tightening torque.

10. The system according to claim 9,
wherein the top nut is tightened against the support by a second tightening torque.

11. The system according to claim 10,
wherein the first tightening torque is greater than the second tightening torque.

12. The system according to claim 11,
including an anti-friction washer between the top nut and the frame.

13. A system comprising:
a support,
a frame, and
a mounting assembly according to claim 7 mounted between the support and the frame with the lower bearing surface of the second component in contact with the support and the steel plate in contact with frame,
wherein the frame includes a fourth through opening having a width greater than a diameter of the rod,
wherein the support includes a fifth through opening,
wherein the rod extends through the fourth through opening and the fifth through opening,
wherein a bottom nut is threaded onto a first end of the rod on a side of the support opposite the adjustable chock, and
wherein a top nut is threaded onto a second end of the rod on a side of the frame opposite the adjustable chock.
